(19) United States
(12) Patent Application Publication
(10) Pub. No.: US 2003/0084124 A1
(43) Pub. Date: May 1, 2003

(54) Automatic information delivery system and method

(76) Inventors: Jason T. Su, Corvallis, OR (US); Rajeev K. Pandey, Corvallis, OR (US); Kevin G. Currans, Philomath, OR (US)

Correspondence Address: HEWLETT-PACKARD COMPANY, Intellectual Property Administration, P.O. Box 272400, Fort Collins, CO, 80527-2400, US

(21) Appl. No.: 09/999,535

(22) Filed: Oct. 31, 2001

(51) Int. Cl. G06F 15/16

(52) U.S. Cl. 709/219

(57) ABSTRACT

A system and corresponding method for automatically delivering information to a user is disclosed. A client, through a screen saver application, requests information be transferred thereto. The transferred information is stored in a corresponding portion of the screen saver application and presented to the user during a time period when the client is idle or inactive.

### FIELD OF THE INVENTION

The present invention generally relates to information retrieval and delivery and, more particularly, to an information delivery system which automatically provides information to a user as a screen saver without user intervention.

### BACKGROUND OF THE INVENTION

As computers become a more standard fixture in our everyday lives, we use them for more than just performing data processing tasks. More and more, computers are being used for entertainment, education, shopping and information gathering and exchange, to name just a few uses. The more tasks performed on computers, the more time users are spending on their computers. After a while, looking at the computer becomes boring. One way to personalize and make the computer more entertaining and fun to use is through the use of screen savers.

A screen saver is a small application program that is stored in computer memory. The screen saver activates and takes over the computer screen, or other display device if there are no recognized keystrokes or mouse movements for a specified duration. As screen savers are only active during extended periods of inactivity, they represent down time when the computer is not performing any function or the user is not using the computer.

It has been contemplated to use this down time, and specifically, use the screen saver to exchange information between nodes or components connected to a network. Known methods for exchanging information using screen savers, however, have been burdened by the requirement that the receiving node must be constantly connected to the network in order to receive information. Thus, the screen saver will only contain information when the computer (or node) that the screen saver is running on is connected to the network. Consequently, no network connection, no information exchange.

Another drawback associated with known methods of exchanging information is that information exchange requires user response or action. Thus, computers down time is not being effectively used.

Thus, there is presently a need for an electronic information delivery system that automatically provides information to a user during offline periods of inactivity and without user intervention.

### SUMMARY OF THE INVENTION

The present invention is directed to a system and method for information delivery. A client station has a screen saver application maintained thereon and a server is operative to transfer information maintained therein in response to a query. The server transfers the information maintained thereon to the client station via a communication medium in response to a request from the screen saver application and the transferred information is presented on the client station offline.

### BRIEF DESCRIPTION OF THE DRAWINGS

The present invention will become better understood upon review of the following detailed description of the invention, taken in conjunction with the following drawings, where like numerals represent like elements, in which:

FIG. 1 is a block diagram of an exemplary network structure employing the information transfer methodology according to the present invention;

FIG. 2 is a flow chart illustrating the steps performed in transferring information between components of the network illustrated in FIG. 1 according to an exemplary embodiment of the present invention;

FIG. 3 is a flow chart illustrating the steps performed in transferring information between components of the network illustrated in FIG. 1 according to an alternate embodiment of the present invention;

FIG. 4 is a flow chart illustrating the steps performed in generating the information to be transferred according to the present invention;

FIG. 5 is a block diagram of an alternate network structure employing the information transfer methodology according to the present invention; and

FIG. 6 is an illustration of how the transferred information is presented to a user according to the present invention.

### DETAILED DESCRIPTION OF THE INVENTION

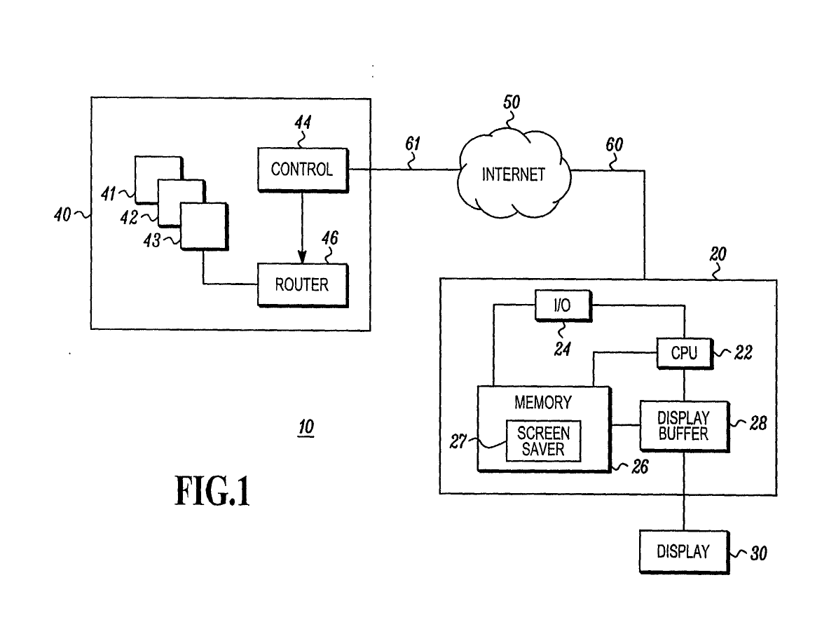

The present invention will now be described with reference to FIGS. 1-6. An exemplary computer network, employing the screen saver information delivery methodology of the present invention is illustrated in FIG. 1. As shown, the network 10 includes a client station 20, having a corresponding display device 30 coupled thereto. The display device 30 can be a cathode ray tube (CRT), a flat panel display, a computer monitor or any suitable display device. The client station 20 is connected to a network resource, such as server 40, through a network connection 50. In the embodiment illustrated in FIG. 1, the network connection 50 is the Internet. It will be appreciated by those of ordinary skill in the art that the network connection can also be performed over a local area network (LAN), a wide area network (WAN) or additional land-line and wireless networks. The server 40 includes a plurality of pages of information 41-43 stored thereon that may be transferred to the client station 20 upon request from the client station. The contents of the pages and the transfer methodology employed by the present invention will be discussed in greater detail below.

The client station 20 includes a central processing unit (CPU) 22, an input output (I/O) port 24, a memory 26 and a display buffer 28. The I/O port 24 is used to send and receive information from input devices such as a keyboard, mouse or touch screen (not shown), or any other device used to enter input into the client station. In addition, the I/O port 24 is used to connect the client station 20 to the server 40 via the network connection on line 60. The memory 26 of the client station stores operating, application and control programs, which are executed by the CPU 22 to control the operation of the client station 20. In addition, a screen saver (“SS”) application 27 is maintained in a portion of the memory 26. The screen saver application 27 is a small program that acquires control over the display device 30 through the display buffer 28, if there are no key strokes or mouse movements recognized by the I/O port 24 for a specified duration of time. When active, the screen saver program 27 is capable of providing entertaining, factual or advertising information on the display. The display buffer 28 is used to maintain and format any visual information that is to be provided on the display 30.

The screen saver application 27 can be enhanced via plug-in applications. The plug-in applications extend the rendering capabilities (e.g., provide enhanced visual quality) of the screen saver application. Examples of such plug-in applications include, but are not limited to, Java, Acrobat®, Ghostscript and XML. These plug-in applications can be delivered in the same channel as content to the screen saver application.

The server 40 includes a plurality of pages 41-43 containing information stored thereon. The pages of information stored on the server 40 can include graphics, videos, wav audio files, screen savers or any type of viewable and/or auditory information. The server 40 also includes a control module 44 which is connected to the network 50 via line 61. A router module 46 is also present within the server 40. The router module 46 controls which individual one or group of pages 41-43 are transmitted from the server 40. The control module 44 may also include authentication and timing functions which control to whom and when the individual one or group of pages 41-43 are transmitted from the server 40. Further, the control module 44 may include an alerting function which sends a notice to authorized client stations that information is available on the server 40 for downloading. In addition, the control module 44, through router module 46, controls the addition of information pages to the server 40 from any outside resources (i.e., another client station, or server).

In application, when information is to be transferred from the server 40 to the client station 20, a request is sent from the client station 20 (via CPU 22) through the I/O port 24. This request is transmitted over line 60 to the server 40, for example, via network 50. The request is received by the control module 44, via line 61, and processed accordingly. If the information requests requires the server 40 to transfer information back to the client station 20, such information is acquired by the router module 46 and transmitted back to the client station 20 via line 61. It is understood that the information transfer can be performed using either a PULL protocol or a PUSH protocol. In the PULL protocol, the requesting device (i.e., client station 20) receives from the transmitting device (server 40) an identification of the location where the requested information can be accessed. Upon receiving the location of the requested information, the client station 20 is then able to extract such information from the transmitting device 40 by directly accessing the location of such information. On the other hand, when PUSH protocol is employed, the transmitting device (server 40) pushes the requested information to the requesting device (i.e., client station 20). Either data transfer protocol is contemplated by the present invention, and is within the spirit and scope of the present invention.

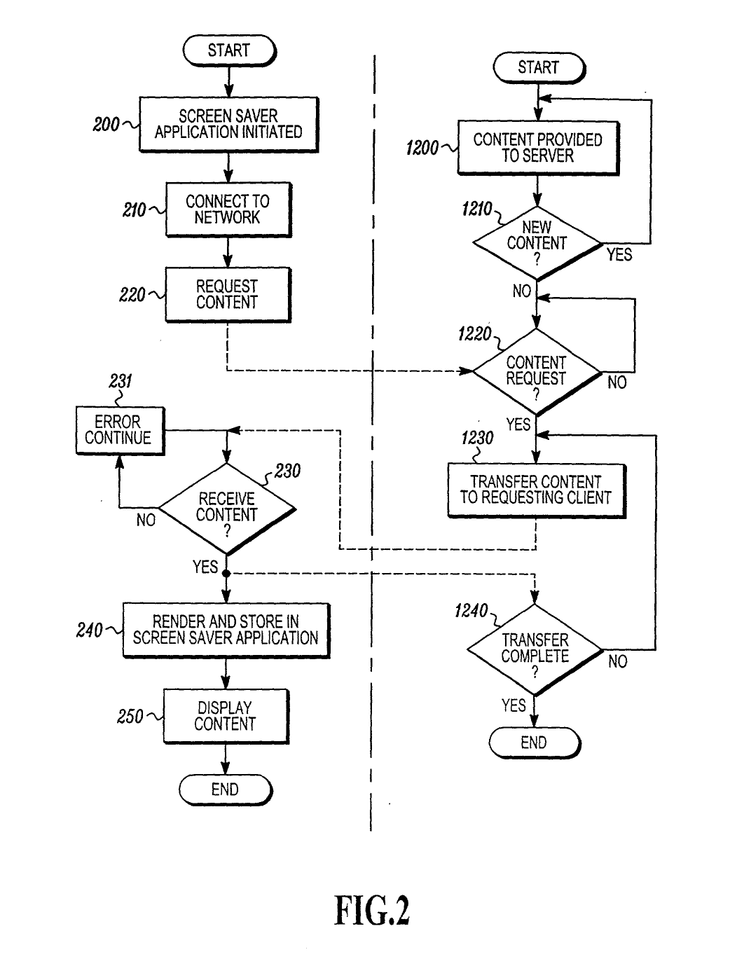

The information transfer methodology employed by the present invention will now be described in greater detail with reference to FIG. 2-4. Due to the significant amount of interaction between the client station 20 and the server 40 and to promote a better understanding of the present invention, the transfer methodology will be described with reference to the both devices simultaneously. The operating steps performed by the client station are illustrated on the left hand side of the corresponding figures. The operating steps performed by the server 40 are illustrated on the right hand side of the corresponding figures. Dashed lines are used to illustrate data exchanges between the client station and the server.

Before any information exchange can take place, however, information must be present within the server 40. For purposes of illustration, the plurality of pages 41-43 present on server 40 will be described as containing content. Content can be considered as electronic data that can be processed by the screen saver application 27 to generate images. The content is not limited to static images. MPEG or other non-static files can also be contained within the server 40. Such pages are initially provided to the server 40 via an outside resource, such as another server or another client station (not shown). This is illustrated as step 1200. At step 1210, the server may check to see if new content is to be provided to the server 40. If new content is available, such content is provided to the server at step 1200. If new content is not available, the server 40 determines whether there has been a request for any of the content present on the server at step 1220. If no content request has been received, the server waits for such a request.

At the client station 20, which can be a personal computer (PC), a mainframe computer, or any customized hardware or software device for processing information, after an initial period of inactivity, the screen saver application 27 is initiated at step 200. Next, the screen saver application causes the client station 20 to connect to the network 50 via I/O port 24 in step 210 and requests content from server 40 in step 220. Upon receiving the request, in step 1220, the server 40 transfers the requested content to the client station 20 in step 1230. In step 230, the client station determines whether the content has been received. If the content has not been received, the client station 20 enters an error routine in step 231. The error routine can be any function from performing a self test operation on the client station, to simply re-requesting the content.

If a successful transfer of content from the server 40 to the client station 20 has occurred, the transferred content is then converted (e.g. rendered) into an appropriate format (e.g., XML, pdf) for display by the screen saver application or appropriate plug-in, if required, and then stored in the requesting screen saver application 27 in step 240. The client station 20 also notifies the server 40 that the content was successfully transferred in step 1240 and the transfer process terminates. Upon completion of the transfer process, the client station 20 disconnects from the network. If the client station 20 still has not received any recognized key strokes or mouse movements, the received content is then displayed on the display device 30 in step 250. As such, the display of the transferred content by the screen saver application 27 on the display device 30 occurs while the client station 20 is offline. By displaying the information offline, network resources are more effectively and efficiently used. In an alternate embodiment and application, the content transfer can be performed while the client station 20 is online.

It should be understood, that the above description of the content transfer operation is only performed when new content is available for downloading. After a successful transfer. The content stored in the screen saver application 27 will be presented on the display 30 each time the screen saver application obtains control of the display 30. In those situations where there is no new content to be transferred, or a connection to the network is not available or obtained, steps 210-240 are not performed. In those instances, the screen saver application 27 simply displays the information stored therein on the display device, whenever there is no recognized key stroke or other input to the client station 20 over a specified period of time.

As the content transfer and display is performed without user intervention, the information transfer methodology of the present invention can be performed at any time. This provides the advantage that information can be transferred during extremely light network usage periods, such as early in the morning or late in the evening. Correspondingly, when the user begins using the client station again, information of interest to the user is automatically presented to them on the display device 30. For purposes of explanation and completeness, the phrase “without user intervention” means that the user is not directly involved in the information transfer operation; the information is automatically transmitted to the screen saver application 27 of the client. No action by the user is necessary to perform or complete the transfer or display operations of the present invention. In fact, the user may not be, and generally is not present in the vicinity of the client station, during information transfer.

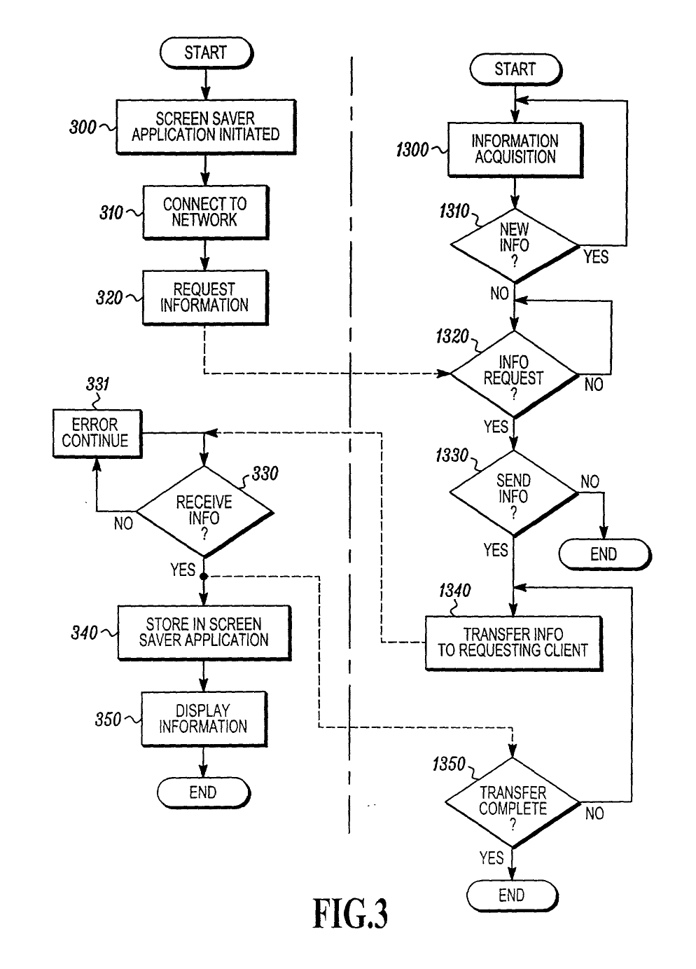

As noted earlier, the server 40 includes a control module 44 which is capable of maintaining information in addition to the content, and controls the operation of the server. In an alternate embodiment of the present invention, the control module 44 of the server 40 may maintain additional information such as: a list of client stations or other operating nodes, that have rights to access information from the server; and a timer which provides for time-controlled release of information. For example, the control module 44 may only allow information to be transmitted from the server in periodic increments, for example, once every twenty-four hours. The operation of such user authentication and time release transfer of information will now be discussed with reference to FIG. 3.

In this alternate embodiment, the screen saver application is initiated in step 300 after no recognized key stroke or mouse communication with the personal computer has been performed in a specified amount of time. The screen saver application 27 causes the client station to connect to the network in step 310, and request information in step 320. The information request is received by the server at step 1320, where the server next determines whether information can be sent to the requesting client station in step 1330. Reasons for denying the request for information may be that the client station does not have authorization to access the content stored in server 40 or the time limit for receiving new information (i.e. content) may not have yet expired. Additional parameters for controlling when and to whom information is transferred will be appreciated by those of ordinary skill in the art and are therefore within the spirit and scope of the present invention. If the server 40 determines that the requested information is not to be sent in step 1330, the process terminates. Thus, the information to be presented on the display 30 by the screen saver application 27, is already stored therein, and will be presented during subsequent idle or down periods.

On the other hand, if the server determines in step 1330 that the requested information can be sent to the requesting client station, the information is transferred to the requesting client station in step 1340. In step 330, the client station 30 determines whether the information has been received. If the information has not been received, the client station enters an error routine 331, similar to that described above with reference to FIG. 2. If the information has been successfully received, the client station 20 sends an appropriate notification to the server 40, in step 1350 that the transfer is completed and the client station 20 is disconnected from the network. On the other hand, if the information transfer was not successfully completed, the server 40 re-transmits the information to the client station 20 in step 1340.

After successful transfer, the information is then rendered by any applicable plug-in applications, if necessary, and then stored in the screen saver application in step 340. The stored information is subsequently presented on the display device 30 in step 350. As noted above, if the information is not to be transmitted to the requesting client for whatever reason, the process then terminates. Any subsequent activation of the screen saver application program 27 on the client station 20 will result in a presentation of information previously stored in the screen saver application. Accordingly, subsequent activation of the screen saver application will result in steps 310-340 not being performed.

If the content to be sent or presented to the user as a screen saver is generated and/or provided by a commercial entity, advertising for such entity or a related entity may be attached to and transmitted with the content. In this fashion, only advertisements of interest to the user can be provided to the user according to a user-defined criteria that is defined or specified in a user-profile stored locally on the client or remotely at the server. This will have the added effect of the user reviewing such advertisement and, potentially, visiting the entity that provided such advertisement.

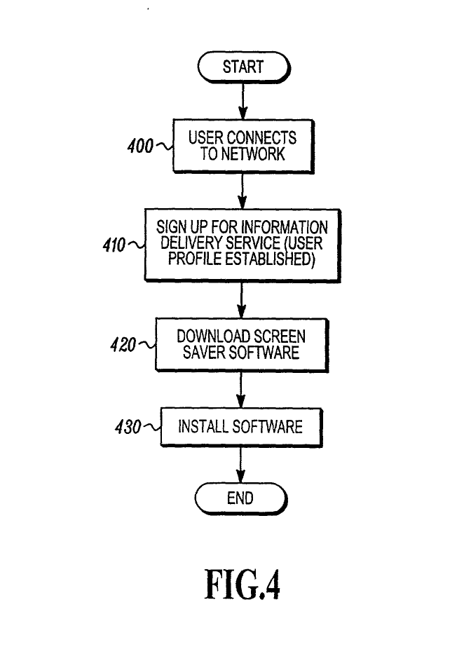

The transfer of information may also be implemented as a subscription service, where a service provider maintains a number of information based screen savers on a server for distribution for a fee. In conjunction with such a subscription service, a user, for example, at client station 20 may pay a subscription fee to receive screen savers containing information of interest. Such information may include daily news briefs, daily business bulletins, sports information, etc. As the screen savers principal use is to entertain the user, having a user provide the areas of interest to the service provider, and presenting the user with a screen saver including only requested information, will promote greater entertainment and value to the screen saver and subscription service. The process for signing up for such a subscription service is illustrated in FIG. 4.

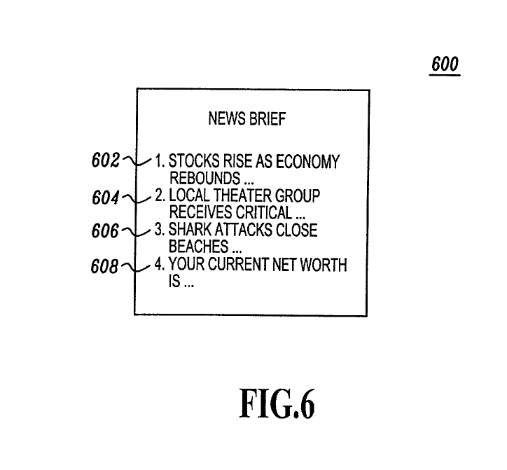

The process begins in step 400 where the user connects to the network. The user then signs up for the information delivery service in step 410. As part of signing up for the subscription service, the user is queried for information regarding their interests; wherein a profile of the given user (i.e. user-defined criteria) is generated and maintained at either the client or the server. In addition to user interests, the user profile may also contain the desired time or times for updating the information on the screen saver. By establishing times for updating the screen saver application, the screen saver application will be able to update its information without any user intervention. In an alternate embodiment, the client profile can be maintained in both the server and the screen saver application 27 located at the client station. In step 420, after the user profile has been created, the software needed to receive the customized screen savers is downloaded from a corresponding network resource in step 420. Additionally, the required software may be mailed to the user. In step 430, the downloaded software is then installed in the screen saver application program 27 of the client station 20. After the screen saver software has been installed in the screen saver application 27 on the client station, the user can then receive updated screen savers containing only information of interest to the user which is acquired in similar fashion to that discussed with respect to FIGS. 2-3 and presented on a corresponding display of the client station during idle periods. An example of a customized screen saver is illustrated in FIG. 6.

As shown in FIG. 6, the screen saver 600 includes highlights of business information 602, performing arts and entertainment information 604 and local information 606. If the user wishes to view the entirely of the information presented in the highlights, the user can activate the link provided on the screen saver and, depending upon configuration, read the entirety of the story from the screen saver or be connected via any known connection protocol such as, for example, XML, HTTP, etc., to a corresponding website or other resource and review such information. Additional information or programs, such as the user's personal finance software or financial holdings 608 can also be reviewed via activation of an appropriate link.

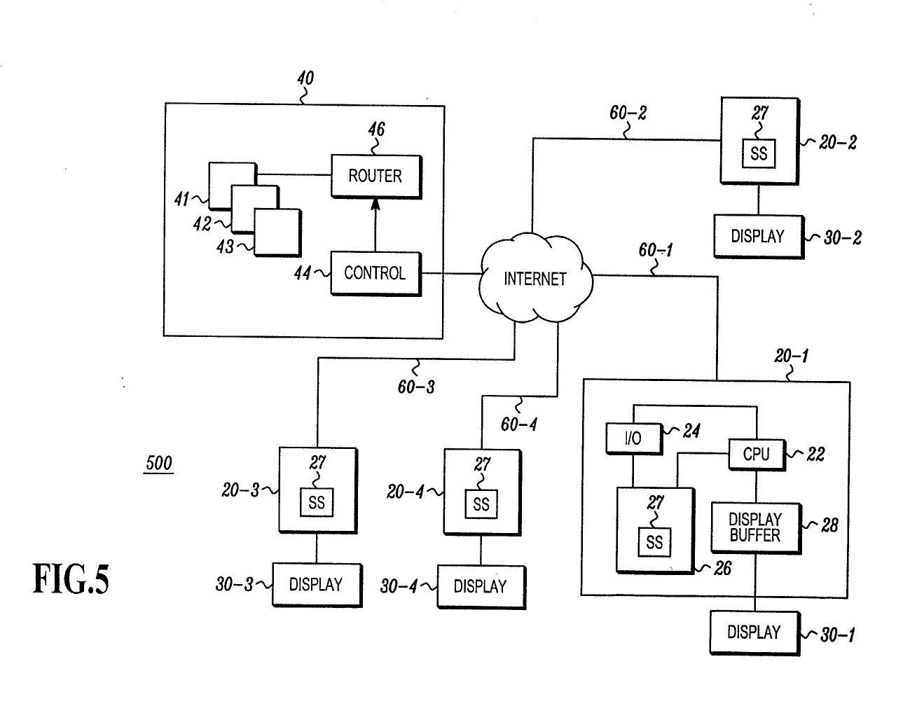

Although described as being a one-on-one client/server relationship, the present invention can be used to generate screen saver based information delivery to any number of users. Such a multi-user system is illustrated in FIG. 5. As illustrated in FIG. 5, a plurality of users, each having a corresponding client station 20-1, 20-2, 20-3, 20-4, can be connected to the server 40 through a corresponding network connection 60-1, 60-2, 60-3, 60-4, respectively. More specifically, client station 20-1 can be connected to the network via connection 60-1. Likewise, client station 20-2 can be connected to the network via connection 60-2. In similar fashion, client station 20-3 can be connected to the network via connection 60-3. And client station 20-4 can be connected to the network via connection 60-4. As with the subscription and non-subscription delivery systems illustrated and described with respect to FIG. 2-4, an individual one group of users (20-1-20-4) can access the server 40 at any one time in the same manner as described above to download screen savers containing information of interest to the users. In corresponding fashion, the received information will be presented on the client station displays as a screen saver during subsequent idle periods of the client stations.

In yet another aspect of the present invention, instead of presenting the information as a screen saver when the corresponding client station is idle, the information can be presented as wallpaper. Generally speaking, “wallpaper” is the background screen present when the computer (or computer screen) is not idle. Thus, the wallpaper application, which is commonly stored in memory 26 may be modified as described above with respect to the screen saver application to present information of interest to a user while the user is using the computer. The information that comprises the wallpaper can be accessed and updated in similar fashion to that described above with reference to FIGS. 2-4. For example, during light usage periods of a network a client station can gain access to a network resource and download information therefrom as described above and store such information in a wallpaper application instead of a screen saver application. In this fashion, information of interest to a user is always available to them while they are working on their client station.

Thus, the present invention has been shown to be directed to a system and method for automatically presenting a user with information of interest as a screen saver on a display device, such as a computer screen. A client station has a screen saver application stored in an accompanying memory. During an idle or inactive period, the screen saver application, without user intervention, connects the client station to a network resource and requests that predefined information stored thereon be transferred to the client station. The transferred information is stored in a portion of the screen saver application for later presentation to the user. After the transfer has been completed, the connection to the network resource is terminated. The information stored in the screen saver application is subsequently presented to the user while the client station is offline.

By employing the method of the present invention, the client station is not taking up network resources while the information is being presented. Additionally, network resources are being more effectively and efficiently used by not having to constantly transfer information to portions of the network. The information transfer can take place at a time scheduled by the user, or can occur in response to a notice provided by the information resource. The foregoing detailed description of the invention and the examples described therein have been provided for the purposes of illustration and description. It is therefore contemplated that the present invention cover any and all modifications, variations or equivalents that fall within the spirit and scope of the basic underlying principles disclosed and claimed herein.

What is claimed is:

1. An information delivery system, comprising
a client station operative to connect to a network resource, the client station including a screen saver application maintained thereon;
a server operative to transfer information maintained therein in response to a query; and
a communication medium for transferring information between the client station and the server, wherein the server transfers the information maintained thereon to the client station in response to a request from the screen saver application and the transferred information is presented on the client station offline.

2. The system of claim 1, wherein the transferred information is stored in the screen saver application.

3. The system of claim 2, wherein the client station has an inactive mode, and the screen saver application displays the transferred information at the client station during the inactive mode.

4. The system of claim 3, wherein the screen saver application requests the information during the inactive mode.

5. The system of claim 2, wherein the transferring and storing of the requested information is done without user intervention.

6. The system of claim 2, wherein the transferred information contains advertising.

7. The system of claim 1, wherein the screen saver application requests information based on user-defined criteria.

8. The system of claim 1, wherein the server is remote from the client station.

9. The system of claim 8, wherein the server includes an application which restricts the transfer of information.

10. The system of claim 9, where in the application includes one of: a timer and a recipient list.

11. The system of claim 1, wherein the screen saver application requests information without user intervention.

12. The system of claim 1, wherein the server includes an application including a list of recipients and a mechanism for notifying client stations that new information is present therein.

13. The system of claim 1, wherein the client station includes a display for providing information to a user.

14. The system of claim 13, wherein the transferred information is presented on the display as a screen saver.

15. The system of claim 11, wherein the client station includes a display, and the requested information is presented on the display as a screen saver.

16. In a client station including a memory, an automatic method for delivering information, comprising:
receiving information from a network resource;
saving the received information in a local application; and
displaying the received information on the client station as a screen saver offline.

17. The method of claim 16, wherein the step of receiving information from a network resource further comprises:
connecting to the network resource;
requesting information from the network resource;
receiving the requested information; and
disconnecting from the network resource.

18. The method of claim 17, wherein step connecting to the network resource is performed without user intervention.

19. The method of claim 17, wherein the step of connecting to the network resource is performed at user-defined times.

20. The method of claim 16, wherein the local application is a wallpaper application, and the received information is presented on the client station as wallpaper.

21. An article comprising a computer-readable medium that stores executable instructions for causing a computer system to:
during an idle period of the computer system, receive information from a network resource;
display the received information on the computer system, wherein the receipt and subsequent display of received information is performed without user intervention.

22. The article of claim 21, further including instructions for causing the computer system to connect to a network resource in order to receive the information and disconnect from the network resource after the information has been received.

23. The article of claim 21, further including instructions for causing the computer system to display the received information offline.

24. The article of claim 22, further including instructions for controlling when the computer system connects to the network resource.

25. The article of claim 21, wherein the instructions further include instructions for controlling what information is received form the network resource.

26. The article of claim 21, wherein the instructions cause the received information to be displayed as a screen saver.

27. The article of claim 21, wherein the instructions cause the received information to be displayed as wallpaper.

28. An article comprising a computer-readable medium that stores executable instructions for causing a computer system to:
during an idle period of the computer system, connect the computer system to a network resource;
receive information from the network resource;
disconnect the computer system from the network resource; and
display the received information as a screen saver offline.

29. The article of claim 28, wherein the instructions cause the computer system to connect to the system and receive the information without user intervention.

30. The article of claim 28, wherein the instructions cause the computer system to display the received information as wallpaper.

31. An information delivery system, comprising:
a server operative to transfer information maintained therein in response to a query from a client station, the client station having a screen saver application maintained thereon; and
a connection to a communication medium for transferring information between the server and the client station, wherein the server transfers the requested information maintained therein to the client station and the client station and the requested information is presented on the client station as a screen saver.

32. The system of claim 31, wherein the transferred information is stored in the screen saver application.

33. The system of claim 31, wherein the client station has an inactive mode, and the screen saver application displays the transferred information at the client station during the inactive mode.

34. The system of claim 33, wherein the screen saver application requests the information during the inactive mode.

35. The system of claim 32, wherein the transferred information contains advertising.

36. The system of claim 31, wherein the screen saver requests information based on user-defined criteria.

37. The system of claim 31, wherein the server includes an application which restricts the transfer of information.

38. The system of claim 37, wherein the application includes at least one of: a timer and a recipient list.

39. The system of claim 31, wherein the server includes an application including a list of recipients and a mechanism for notifying client stations that new information is present thereon.
